(19) United States
(12) Patent Application Publication
(10) Pub. No.: US 2023/0147039 A1
(43) Pub. Date: May 11, 2023

(54) IMMERSIVE LEARNING APP FRAMEWORK FOR COMPANION APP GATEWAY

(71) Applicant: IntelliMedia Networks, Inc., Leesburg, VA (US)

(72) Inventors: Darshan Sedani, Cerritos, CA (US); Teodros Gessesse, Leesburg, VA (US); Devang Ajmera, Gujaratvv (IN); Joy Shah, Gujarat (IN); Rajkumar Ramakrishnan, Gujarat (IN)

(73) Assignee: IntelliMedia Networks, Inc., Leesburg, VA (US)

(21) Appl. No.: 17/838,924

(22) Filed: Jun. 13, 2022

Related U.S. Application Data
(63) Continuation of application No. 17/592,371, filed on Feb. 3, 2022.
Application No. 17/592,371 is a continuation of application No. 17/592,296, filed on Feb. 3, 2022.
Application No. 17/592,296 is a continuation of application No. 17/523,504, filed on Nov. 10, 2021.

(51) Int. Cl. G09B 5/06

(52) U.S. Cl. CPC G09B 5/065

(57) ABSTRACT

A component module of Immersive Learning Application (ILA), ILCAG is a mobile app which generates and manages companion apps in memory of the mobile computing device. The companion apps cooperate with one or more integrated tracker apps in memory of a wearable device to provide a combined functionality to the wearable device. A companion app communicates with an integrated tracker app to provide at least extended capabilities for the integrated tracker app including adding connectivity to the Internet to access online services and gather data on behalf of the integrated tracker app via the integrated tracking app submitting a request to an application programming interface for the companion app. The mobile app coordinates activities between i) multiples instances of the companion app loaded in the memory of the mobile computing device and ii) the integrated tracker apps running in the memory of the wearable device.

### CROSS-REFERENCE TO RELATED APPLICATIONS

This application is a continuation application of U.S. patent application Ser. No. 17/592,371, filed Feb. 3, 2022, which is a Continuation of U.S. patent application Ser. No. 17/592,296, Feb. 3, 2022, which is a Continuation of U.S. patent application Ser. No. 17/523,504, filed Nov. 10, 2021, the entire disclosures of which are herein incorporated by reference as a part of this application.

### FIELD

This invention is in the field of the interaction among and between educational software systems, learning systems, courseware management, informational communications and visualization systems, and virtual reality presentation system software, students, teachers, and learning system administrators.

### DESCRIPTION OF RELATED ART

As the Internet has grown in speed and computing power, and with the rise of cloud-based data storage and software as a service, online education has become increasingly enabled. Many efforts at standardizing online education and providing tools to enable multiple kinds of course materials to be mixed together have arisen. A critical threshold has also been reached where networking bandwidth and data transfer speeds of massive amounts of data are now sufficient to allow blending of live data streams. These factors have served to open a wide range of opportunities for designing and serving so-called massive open online courses to students worldwide.

Another convergence of technology is also maturing: the widespread availability of multiple kinds of user devices such as laptop computers, mobile phones, mobile tablets of various kinds, next-generation television program management services (so-called over-the-top (“OTT”) services), and virtual reality devices and related services. These devices are becoming sufficiently commonplace that widespread familiarity with their use is an enabler for convergent inter-operation of such device to enhance information delivery and interactivity. Users of such devices now often possess sufficient skills to be able to operate multiple devices and coordinate information between them with ease.

Taken together, these factors provide opportunities for development of inter-operating education systems which take advantage of multiple information delivery modalities including plain text, interactive text, audio, video, collaborative workspaces, and various combinations of live interactions between students and teachers while sharing and even contributing to information flows displayed on multiple devices simultaneous.

Such new systems serve to enhance learning rates of student, collaboration rates among professionals, and may even serve to enhance the rate of new discoveries in science by scientific research communities.

The Immersive Learning Companion App disclosed hereunder is a component of one such integrative software system in this new genre.

### SUMMARY

Immersive Learning Companion App Gateway (ILCAG) is a component system of Immersive Learning Application (ILA), which in turn is a cloud-based integrated software system providing a rich context for education of trainees, employees in enterprise organizations, students in institutional settings, as well as individual students, through the operation of courseware, testing, skills validation and certification, courseware management, and inter-personal interactions of students and teachers in various ways. The core concept is providing a learning environment which is immersive in the sense that the student can utilize every available communications and display technology to be fully immersed in a simulated or artificial environment. The student is able to tune this environment to his/her own optimum style of information absorption.

ILCAG is a mobile app system which generates and manages one or more companion apps in memory of one or more mobile computing devices. The companion apps cooperate with one or more integrated tracker apps in memory of a wearable device to provide a combined functionality to the wearable device. A companion app communicates with an integrated tracker app to provide at least extended capabilities for the integrated tracker app including adding connectivity to the Internet to access On-line services and gather data on behalf of the integrated tracker app via the integrated tracking app submitting a request to an application programming interface for the companion app.

ILCAG communications operates by means of socket programming, providing Internet addressing of endpoints, an end-to-end protocol, and port numbers to enable locating and connecting to the desired applications at the endpoints.

All assets visually presented to the user are rendered in Realtime using the native resolution of the devices on which the assets are presented, selectable from among the available native resolutions. Rich media text and graphics are synchronized in Realtime on on all participating devices.

### BRIEF DESCRIPTION OF THE DRAWINGS

FIG. 1 is a diagram illustrating the major system components and their data flows in relationship to each other.

FIG. 2 is a diagram illustrating data flows from users' perspective.

### DETAILED DESCRIPTION

In ILACAG, a mobile app generates and manages companion apps in a memory of the mobile computing device. The companion apps cooperate with one or more integrated tracker apps in a memory of a wearable device to provide a combined functionality to the wearable device. A companion app communicates with an integrated tracker app to provide at least extended capabilities for the integrated tracker app including adding connectivity to the Internet to access On-line services and gather data on behalf of the integrated tracker app via the integrated tracking app submitting a request to an application programming interface for the companion app. The mobile app coordinates activities between i) multiples instances of the companion app loaded in the memory of the mobile computing device and ii) the integrated tracker apps running in the memory of the wearable device.

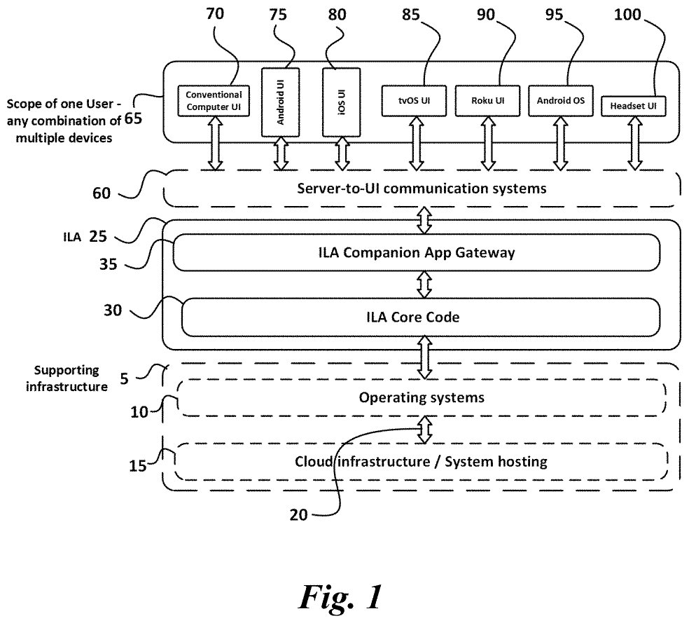

Referring to FIG. 1, ILACAG is supported in a context of other software which are not parts of which ILA is comprised but are necessary for ILA operating correctly. These components are illustrated in dashed outlines. A Supporting infrastructure 5 is comprised of a so-called cloud hosting environment of servers 15, operating systems 10, and Internet components in communication with each other by means of data flows 20, indicated generically by double arrows throughout FIG. 1. Communications between said servers and remote user devices is through generic Internet server-to-user-interface communication systems 60.

The software architecture of ILA 25 is comprising a body of core code 30, together with distinct modules providing specific services. The core code 30 in turn operates a companion app gateway, ILACAG 40.

The module 40 is communicating through said server-to-user-interface communication systems 60, to one or any combination of an array of user devices within the scope 65, the array of devices and displays comprising a conventional computer display 70, an Android user interface display 75, an iOS user interface display 80, a tvOS user interface display 85, a Roku user interface display 90, an Android OS user interface display 95, and a virtual reality headset user interface display 100.

In greater detail: The ILCAG is a communication system, comprising a centralized platform configured to be used by at least two mobile virtual operators (MVNOs) and comprising equipment and services management devices, subscriber/subscription data management devices and a call server, arranged to manage jointly a user control plane layer, wherein each MVNO provides subscription-based service for subscribers, and distributed media gateways connected to said centralized platform via a backbone network, each of the at least two MVNOs includes a routing canter and one or more of the distributed media gateways that are associated with the MVNOs, wherein each of the distributed media gateways interconnects the centralized platform to the routing center of a communication network for the MVNO, said each routing center being managed by the centralized platform and configured to route calls from communication terminals to the communication network, and each of the distributed media gateways further being configured to control the user control plane layer jointly with the centralized platform, the at least two MVNOs not owning and not operating the backbone network, wherein said centralized platform comprises devices for providing centralized services arranged to provide said communication terminals of subscribers with chosen centralized services, and a centralized media gateway connected to said backbone network and to said devices for providing centralized services and arranged, in case of transmission of the user control plane layer by the at least one distributed media gateway, to manage the user control plane layer to provide at least a certain number of said centralized services to the communication terminals of the subscribers who have subscribed to said centralized services.

Systems and methods are provided for intra-process communication in an ILA framework. The system operates through socket programming, using unique Internet addressing, carrying end-to-end communications protocols, and utilizing port numbers at the endpoints to locate and enable the appropriate applications to transmit and receive their communications. The Internet protocol TCP is used as the transport-layer protocol, because it is comprising the characteristics of reliable, guaranteed communications through guaranteed connections, with flow control, packet sequencing, and error correction. The use of socket programming enables full-duplex communications once a connection is established, and supports data streaming, which is used in some aspects of ILACAG and related LTMS operations. The use of socket streams specifically enables the exact same information to be displayed on both ends of a communications channel, (or on multiple ends of multi-part communications channel instances), supporting the simultaneous visual displays characteristic of the ILA and LTMS systems.

A custom requester is registered with a framework configured to run and coordinate one or more requesters and one or more providers, wherein the framework provides an application programmer interface for the requesters and providers. A first requester from the one or more requesters starts a backup process for a first data set associated with a first application. The first requester determines that the data storage device associated with the first data set and the first application is exported by a data management system. The first requester selects a first provider to create a backup of the first data set for the backup process, wherein the first requester and first provider are separate threads in the same process space that can communicate directly with each other using one or more intra-process communication channels.

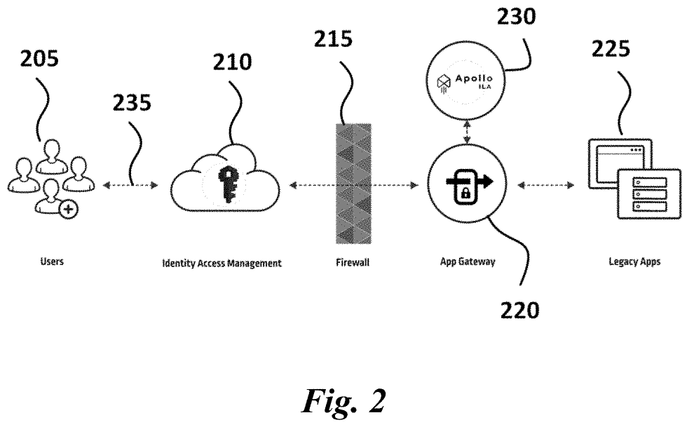

FIG. 2 illustrates data flows of user activity through the ILACAG. There are many possible users 205 using the system like admin user, guest users, and users having limited access. Data flows are shown as arrows 235, typical of multiple places in the figure. The users are able to login to the system by providing the credentials. The system checks the username and password by using an identity access management subsystem 210. The identity access management helps in the encryption and decryption of the password and checks the necessary details entered by the user with the database. This also checks the authorization for the users based on the roles and permissions assigned to the user. To prevent from any type of hacks like DDOS, a firewall 215 enables the system to limit the user by having access for selected IPs, networks or regions. Token validation is performed in the firewall for all the requests coming from the users. Users are able to access the app gateway 220 which is the front end of the ILA/LTMS system 230. The users are able to view the complete data of their legacy apps 225 based on the permissions. They are also able to import/export the data from their legacy apps. All the operations for the existing legacy apps are performed through the App Gateway 220. Legacy data from legacy apps, incorporated into the new process of the ILA/LTMS enhance the user experience for users.

What is claimed is:

1. A software structure and operating means creating a gateway between a companion app framework and one or a plurality of operating systems, comprising
a) A companion app gateway structure with a plurality of callable communications interfaces as a gateway supporting communication between and among a centralized server operating system and one or a plurality of devices operating a tvOS operating system; and
b) A companion app gateway with a plurality of callable communications interfaces supporting communication between and among a centralized server operating system and one or a plurality of devices operating a Roku OS operating system; and
c) A companion app gateway with a plurality of callable communications interfaces supporting communication between and among a centralized server operating system and one or a plurality of devices operating an iOS mobile operating system; and
d) A companion app gateway with a plurality of callable communications interfaces supporting communication between and among a centralized server operating system and one or a plurality of devices operating an Android mobile operating system; and
e) A companion app gateway with a plurality of callable communications interfaces supporting communication between and among a centralized server operating system and any combination of one or a plurality of devices operating a tvOS or Roku OS or iOS or Android mobile operating systems.

2. The software structure and operating means of claim 1, synchronizing in Realtime the display of user activity on one user-operating device with one or a plurality of other operating devices under the control of the same or a different user or users, enabling versatile mixing of user device display utilization, said synchronizing selectable at user option as to occurrence and on which devices.

3. The software structure and operating means of claim 1, rendering in rRealtime all assets presented to the user at selectable resolutions native to each device type, including the highest available resolution of each device type.
